(19) United States
(12) Patent Application Publication
(10) Pub. No.: US 2012/0221476 A1
(43) Pub. Date: Aug. 30, 2012

(54) Medical Job Bidding System

(76) Inventor: Alexander C. Candelario, San Marcos, TX (US)

(21) Appl. No.: 13/034,479

(22) Filed: Feb. 24, 2011

(51) Int. Cl. G06Q 10/00

(52) U.S. Cl. 705/321

(57) ABSTRACT

An electronic job auction system for medical professionals. The system considers the unique needs of a medical professional and healthcare facility and medical group's (FMG) emphasis for qualification and license. In a bidding process, medical professionals are grouped into groups according to a FMG's preference, and a FMG has the option to choose the bidding winner from any of the bidding groups or bidding medical professional with the highest matching score. Thus, the most qualified medical professional doesn't have to compromise his bidding position. Conversely, a medical professional is able to post his/her job preferences and availability, and have a FMG bid for the medical professional. Similarly, FMGs are grouped into bidding groups according to a medical professional's preference, and a medical professional has the option to choose the bidding winner from any of the bidding groups or the bidding FMGs who has the highest matching score.

### DESCRIPTION OF RELATED ART

The present application relates to a job auction system, and more particularly to medical job auction system where medical professionals may freely bid jobs according to their needs and credentials. This job auction system will allow healthcare facilities and medical groups (FMGs) to bid on the medical professionals that register to use the system.

Note that the points discussed below may reflect the hindsight gained from the disclosed inventions, and are not necessarily admitted to be prior art.

As demands over services of medical professionals remain high, the medical staffing industry stands a multibillion dollar market. As of 2009, there were over 700 medical staffing firms. However, the industry still relies on the traditional recruiting methods, mainly a recruiter from a staffing agency or facility presents the job to a medical provider as a potential candidate, and the recruiter charges a fee to the employer if the recruiting becomes successful; or a medical job seeker searches for jobs on the market and contacts a potential medical employer on his/her own initiative. The problem with the traditional way of recruiting is its high cost and inefficiency.

The internet and its associated electronic commerce has dramatically increased market efficiency in almost all fields it touches. Specialized auction systems for goods such as “eBay.com” and services such as “priceline.com” and “elance.com” have been successfully implemented.

Online auction systems for some types of medical practices have also been attempted. For example, U.S. Pat. No. 6,006,191 discloses a system where certain remotely accessible physicians' services are auctioned so as to better distribute the availability/utilization of those services across geographic/time domains. The patent is specifically directed toward the reading of radiological and other medical images (i.e., image-reading diagnostic services). A self-organizing, distribution system combined with bid queues establishes a market place which allows for continuously negotiated prices with control being totally in the hands of the patient/gate keeper and the diagnostic physician.

U.S. Pat. No. 6,035,288 is generally directed to online bidding for a service, i.e., any service, medical or otherwise, in which the price can be negotiated.

U.S. Pat. No. 7,657,479 discloses an online electronic system that allows prospective patients/clients as bidders and professional service providers as auctioneers to negotiate competitively for desired fees for proffered services through an interactive on-line communications network. The system verifies the various medical providers' credentials and background information. Patients will then bid the services provided by the medical providers.

However, the above described auction models cannot be used to create a job auction market for medical professionals who would function as bidders, since there are not only price negotiations, there are job requirements as well as qualification requirements, best price may not reflect the bidder's experience and education. A price-focused auction model would not produce the best results for a medical employer.

### SUMMARY

The present application discloses new approaches in building a medical job auction market for medical professionals, and healthcare facilities and medical groups.

In one embodiment, medical professionals and healthcare facilities and medical groups will be able to search the system to preview job opportunities and medical professional candidates, without requiring full registration.

In one embodiment, medical professional bidders are registered and licenses are verified by the system. Once the provider is registered, the medical professional will create a profile and the system will populate an “Opportunity List” based upon their search perimeter history. The medical professional will be able to share his profile with other registrants; inform other registrants of interesting job postings via SMS, emails and messages; save interesting job postings; and manage their healthcare career and personal lives.

In one embodiment, for a fee, either a one-time fee or membership, healthcare facilities and medical groups may post medical jobs in the auction system for bidding, and the recruiter has an option of setting preference or weight factor for each of the qualification requirements. The healthcare facilities and medical groups will have a “Facility View”, which will include details of the location, job listings, and facility ratings/reviews.

In one embodiment, the bidding system automatically evaluates each medical professional's qualifications against the position they are bidding, and provides a matching score for each bidder. Medical professionals may be grouped according to their years of experience or education, preference of job, and qualifications.

In one embodiment, a medical professional can post their availability to provide services. The healthcare facilities and medical groups can then bid for the medical professional's services. Healthcare facilities and medical groups may be grouped according to geographic location, start date, compensation range, job requirements, facility size, ownership, and patient profile mix.

In one embodiment, the bidding system generates a winner for each bidding group at the end of bidding, and the healthcare facility and medical group or medical professional have the option to select a winner from one of the group, or the bidder with the highest matching score. The healthcare facilities and medical groups and medical professional bidding will also have the option to “hire now”, and bypass the bidding for a predetermined set fee.

In one embodiment, medical professionals and healthcare facilities and medical groups will be categorized according to different professional fields, and they may be automatically linked with professional networks; and targeted advertisement space may be made available to commercial product advertisers.

In one embodiment, bidders will able to research different areas affecting the medical industry and jobs. Specifically, bidders will be able to search salary requirements and CEUs for a specific field or geographic area. Bidders will be able to share articles and industry news. Bidders will be able to search for information regarding a geographic location.

In one embodiment, bidders will be able to provide feedback and rate the medical professional or healthcare facility or medical group. Bidders will be able to provide comments about the groups, locations and professionals they have worked with as a result of winning a bid. The bidders will also be able to make recommendations to other bidders.

The disclosed innovation, in various embodiments, provides one or more of at least the following advantages. However, not all of these advantages result from every one of the innovations disclosed, and this list of advantages does not limit the various claimed inventions. The system will allow a medical employer to locate a medical professional with high efficiency and low cost. The system also enables a medical professional to bid on a job with ease, the match score may allow the most qualified bidder win the job, not just the winning bidder. Also, the grouping aspect of the system allows the bidders to be compared to their contemporaries and the winning bidding prices are thus fairer. The system will create a transparent community that allows medical professional and healthcare facilities and medical groups to share information and negotiate directly.

### BRIEF DESCRIPTION OF THE DRAWINGS

The disclosed application will be described with reference to the accompanying drawings, which show important sample embodiments of the invention and which are incorporated in the specification hereof by reference, wherein:

FIG. 1 schematically shows an example list properties associated with a registered medical professional bidder account in accordance with this application.

FIG. 2 schematically shows an example list properties associated with a registered healthcare facility or medical group account in accordance with this application.

FIG. 3 schematically shows an example process for a healthcare facility or medical group to place a medical job for bidding in accordance with this application.

FIG. 4 schematically shows an example process for a healthcare facility or medical group to place a medical position for bidding in accordance with this application.

FIG. 5 schematically shows an example bidding process for a job in accordance with this application.

FIG. 6 schematically shows an example bidding process for a medical professional in accordance with this application.

FIG. 7 schematically shows an example bidding option available to all bidders in accordance with this application.

FIG. 8 schematically shows an example list of functional modules that may be included in the auction system in accordance with this application.

FIG. 9 schematically shows an example list of professional contacts with other established social networks in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

The disclosed medical job auctioning system is a software as a service that adopts the central server network model wherein medical professional and facilities and medical groups are linked via the internet and they can use their individual personal computers, mobiles, internet capable game machines to interact with each other through one or more central servers.

It is contemplated that this job bidding and auction process can be applied to any professional job bidding.

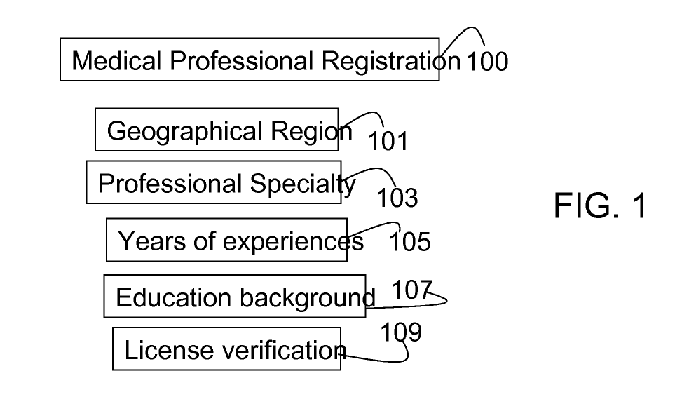

In reference to FIG. 1, the medical job auctioning system is a membership based electronic system, medical professionals need to register to be a valid bidder. The registration process 100 may include filling a few information fields pertinent to medical professions, for example, the geographic location of the medical professional 101, the professional specialty(ies) 103, the years of experience in each specialty 105, fields of education background 107, and any medical licenses 109. The auction system then verifies the license information by searching the published medical licensee database of each state. The system may require the bidder to agree for a credit report checking based on provided information, and to provide names of references. Bidder information, as well as user name and password, will be saved in a database and can be accessed each time the bidder login onto the auction system. Copies of curriculum vitas, licenses, diplomas, certificates may also be stored in the system, and shared amongst the registrants via email, messaging, and social networks. After registration, the system will populate an “Opportunity List” based upon the professional search perimeter history.

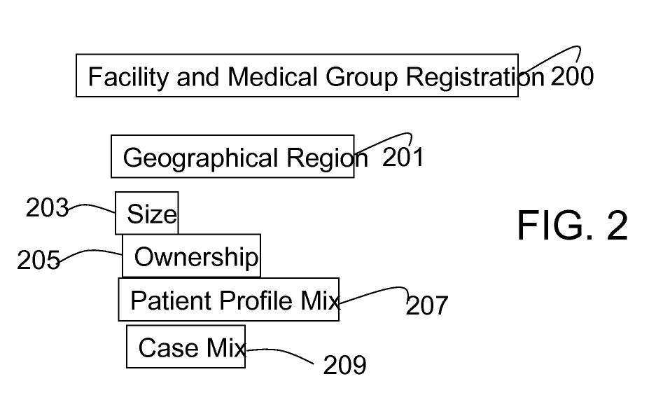

In reference to FIG. 2, the medical job auctioning system is a membership based electronic system, healthcare facilities and medical groups or job providers need to register to be a valid bidder. The registration process 200 may include filling a few information fields pertinent to healthcare facilities, for example, the geographic location of the facility 201, size 203, ownership 205, patient profile mix 207, and case mix 209. The system may require the bidder to agree for a credit report checking based on provided information, and to provide names of references. Bidder information, as well as user name and password, will be saved in a database and can be accessed each time the bidder login onto the auction system. Each healthcare facility and medical group will have a “Facility View” consisting of location, size, facility rating, ownership, patient profile mix, facility video, and provider comments.

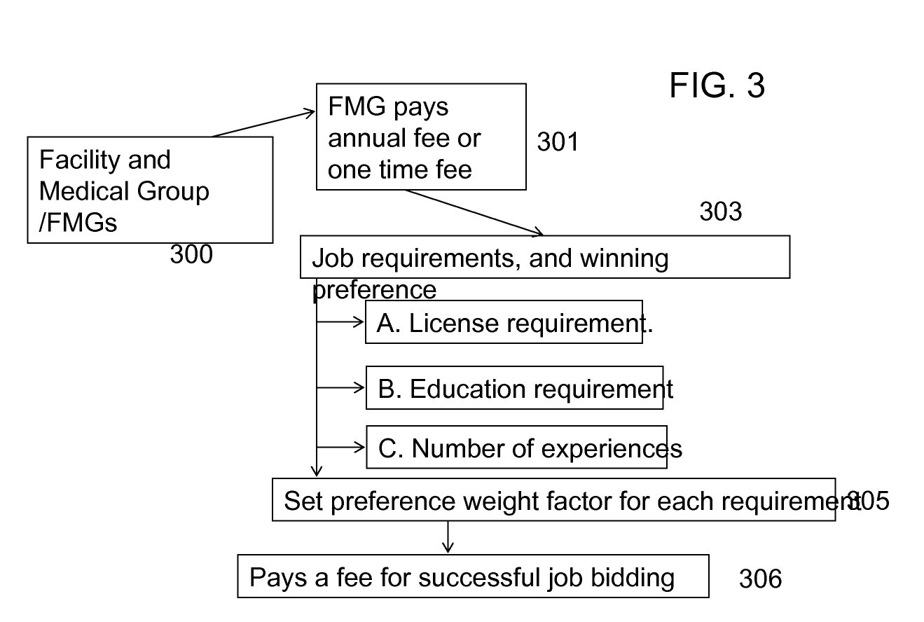

In reference to FIG. 3, facilities and medical groups (FMG) or job providers 300 may post a medical position on the auction network by paying either a one time fee or buying a membership at step 301. The amount of fee is to ensure that any posted position is real and the FMG is serious about the position. But the total cost of recruiting a medical professional should be significantly less than what a conventional recruiter would charge.

The healthcare facilities or medical groups then may publish a medical position by providing a job description and required qualifications at step 303. The healthcare facilities or medical groups may also specify the desired preference in selecting a winner, for example, the highest matching score of background with the best bidding price. The healthcare facilities or medical groups may also provide a weight factor for a given list of qualifications at step 305, for example, the FMG may emphasize number of years of experience by increasing the weight factor to bigger than one. The FMG may select the choice of the amount of payment for a successful bidding to the system at step 306. The time period of auction may also be determined or selected at step 306. The bidders will have the option to “work now”, by selecting to complete the job for a predetermined compensation. The FMG does not have to choose from any of the bidders.

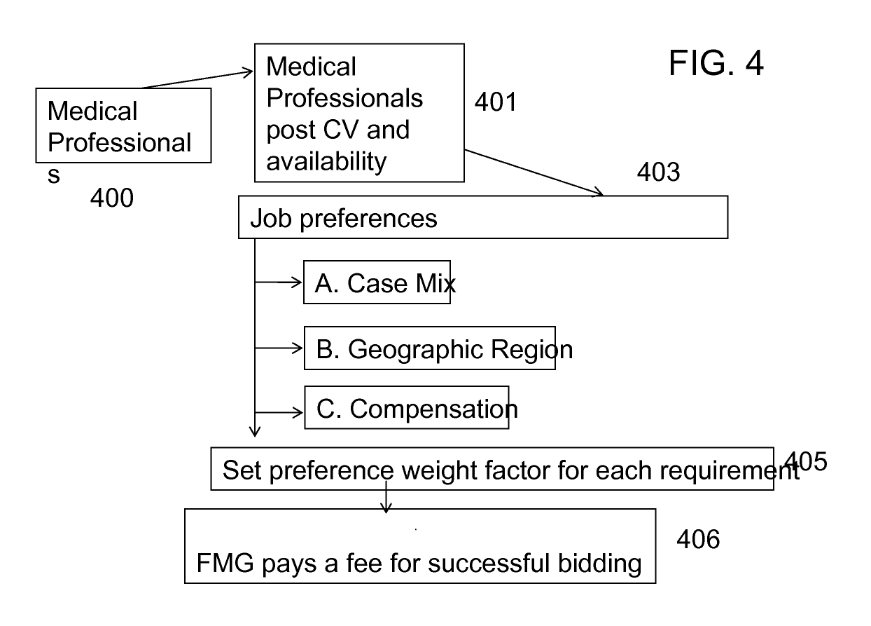

In reference to FIG. 4, a medical professional 400 may post a CV and calendar of availability on the auction network after registering at step 401. The medical professional then may publish his availability by providing job preferences at step 403. The medical professional may also specify the desired preference in selecting a winner, for example, a specific case mix with the best bidding price. The medical professional may also provide a weight factor for a given list of qualifications at step 405, for example, the professional may emphasize geographic by increasing the weight factor to bigger than one. The professional may select the choice of the amount of payment for a successful bidding to the system at step 406. The time period of auction may also be determined or selected at step 406. The bidders will have the option to “work now”, by selecting to hire the professional for a predetermined compensation. The medical professional does not have to choose from any of the bidders.

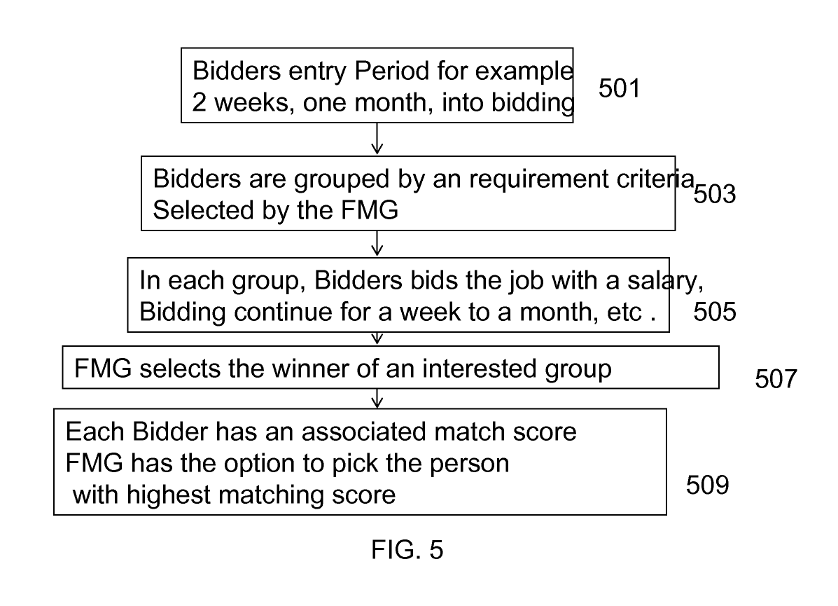

In reference to FIG. 5, after bidding starts, there may be a period of time set for bidder entry at step 501 during which bidders may enter for bidding. This period may vary, for example between one week to two months, depending the preference of the healthcare facilities and medical groups. During the entry time, a bidder does not have to place a salary bid, he/she can simply submit his/her qualification and wait. At the same time, at step 501, a bidder may submit his/her salary bid as well as personal qualification. The system automatically gathers all entered bidders' qualifications, and group them according the preference set by the job provider at step 503, for example, according to number of years of experience, 1-3 years in one group, 3-6 years in another group, etc. For each bidder a matching score is automatically calculated by the system based on the job requirement, FMG's preferred weight factor and a bidder's qualification. For example, a job requires four qualifications, a bidder's background matches three of the qualifications, with each qualification weight factor as 1, the matching score is 0.75 (three divided by four.)

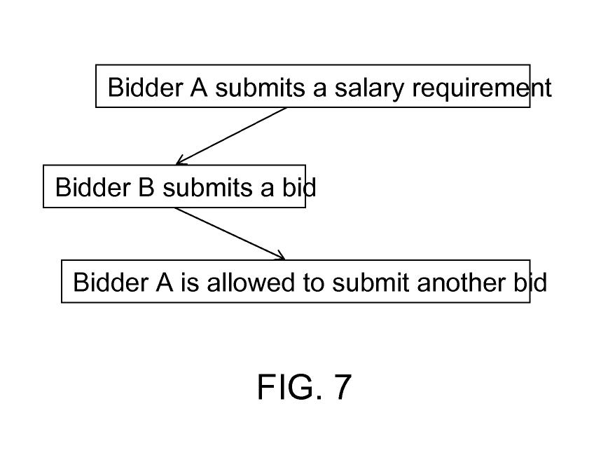

At step 505, bidding formally starts, each of the entered bidders should submit his/her salary bid. Bidding can continue for several weeks. As shown in FIG. 7, a bidder must wait for a counterbid before placing a new bid. The bidder has the option to receive a notification of a counterbid via text or instant message. When the bidding period is over, the system generates a winner from each group at the step 507. Generally, the lowest salary bidder in each group becomes the winner of the group. The FMG has the option to select one winner from any of the groups. At step 509, the FMG also has the option to select the bidder who has the highest matching score regardless what his bidding salary stands in the group.

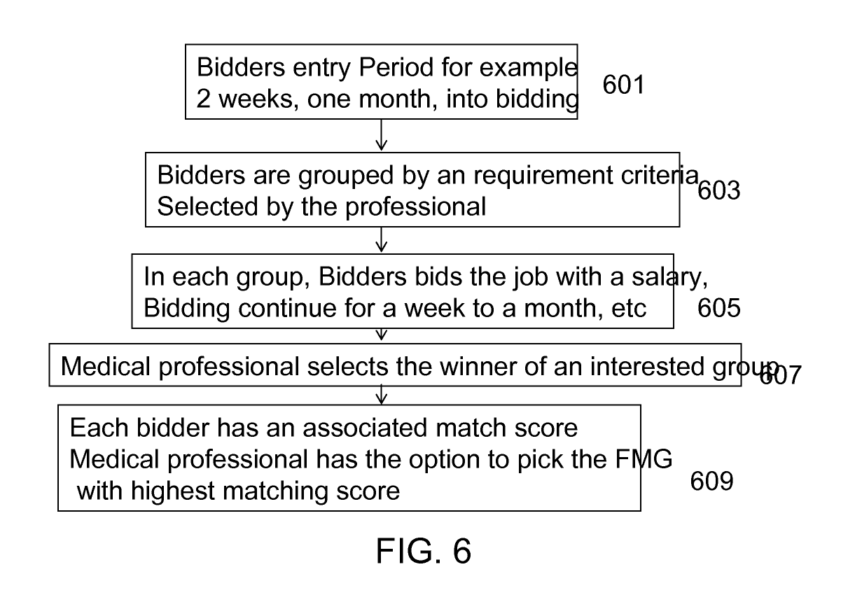

In reference to FIG. 6, after bidding starts, there may be a period of time set for bidder entry at step 601 during which bidders may enter for bidding. This period may vary, for example between one week to two months, depending the preference of the medical professional. During the entry time, a bidder does not have to place a salary bid, he/she can simply submit his/her job or facility specifications. At the same time, at step 601, a bidder may submit his/her salary bid as well as facility and specifications. The system automatically gathers all entered bidders' specifications, and group them according the preference set by the medical professional at step 603, for example, according to geographic location, case mix, compensation, etc. For each bidder a matching score is automatically calculated by the system based on the job preferences, medical professional's preferred weight factor and a bidder's specifications. For example, a professional seeking a job requires four preferences, a bidder's job specifications matches three of the preferences, with each preference weight factor as 1, the matching score is 0.75 (three divided by four.)

At step 605, bidding formally starts, each of the entered bidders should submit his/her salary bid. Bidding can continue for several weeks. As shown in FIG. 7, a bidder must wait for a counterbid before placing a new bid. The bidder has the option to receive a notification of a counterbid via text or instant message. When the bidding period is over, the system generates a winner from each group at the step 607. Generally the highest salary bidder in each group becomes the winner of the group. The medical professional has the option to select one winner from any of the groups. At step 609, the medical professional also has the option to select the bidder who has the highest matching score regardless what his bidding salary stands in the group.

The bidding group feature allows bidders of similar background or specifications to bid together, thus providing an opportunity for bidders of different background or specifications to be considered. The option for choosing the bidder of best matching score provides a winning opportunity for the most qualified person without compromising his salary position. In addition, a medical professional can choose to work at a facility based on factors other than salary.

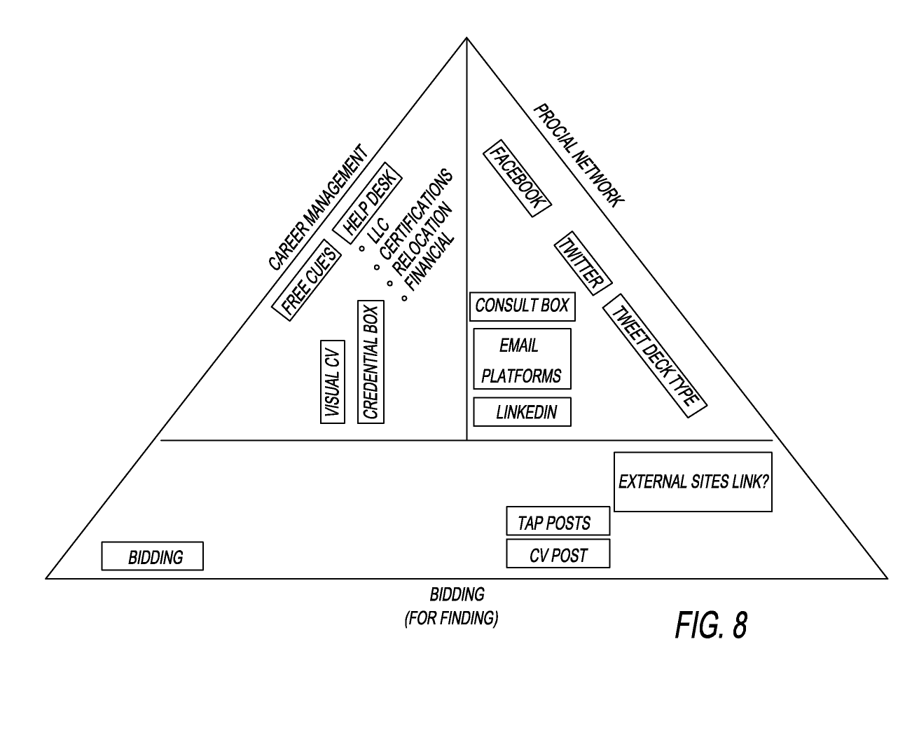

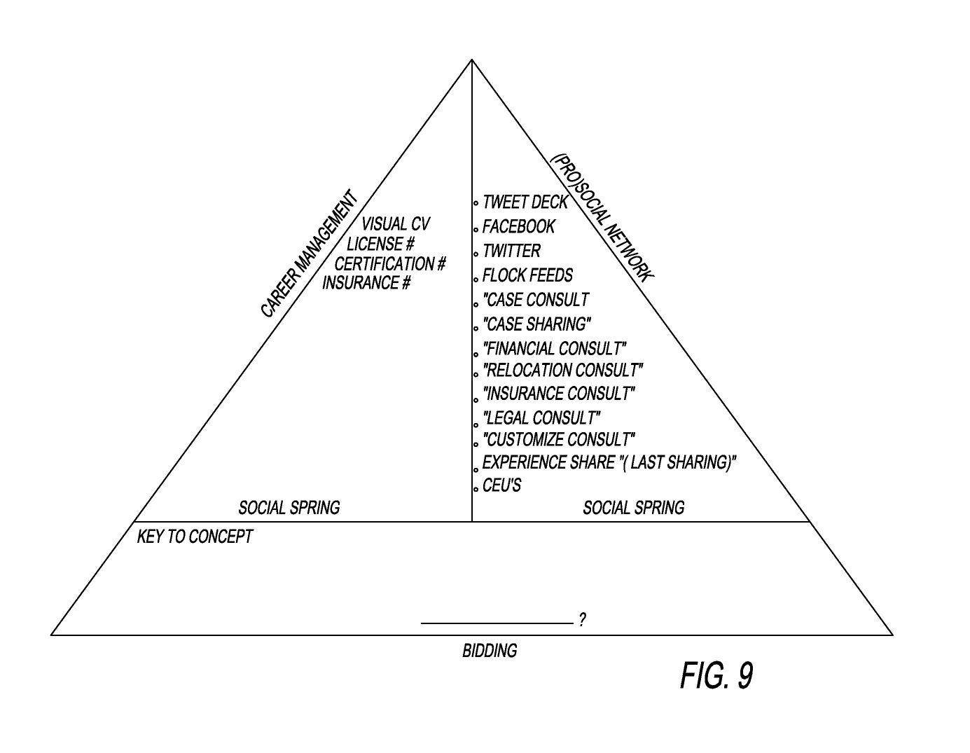

As shown in FIGS. 8 and 9, the auction system also provides for commercial advertisement space, vendors, such as, professional liability insurance carriers, health/life insurance carriers, hotels, airlines, car rental companies, CPA's, lawyer, etc. will be allowed to compete for the medical professionals' and FMG's business via a fee or advertisement space to market to the enrolled medical providers. Vendors will have the opportunity to target specific specialties, geographical areas, etc.

In this system, FMGs and medical job providers would have immediate access to medical professionals that have credentialing information ready and complete, and have a ranking profile based upon a proprietary algorithm composed of past education, experience, performance, credentialing, etc. The system would charge drastic reduction of placement fees (90-95% reduction). Both job seekers and FMGs or job providers would enjoy a true market pricing and access to a much larger talent pool.

On the other hand, medical professionals would enjoy the immediate access to job/assignments that have full information on the site and a ranking profile. Medical professionals will have control of their career search and assignments, will be able to have and be a member of an Exclusive Specialty Social Media, and enjoy privileging and assistance in completing and submitting applications, frequent communication with all needed parties, documentation of the entire process, and continuously following up until privileges are granted. The medical professional will have the option to access medical licensing organization directly from the site, and seek assistance with the licensing process.

The system may also serve as a professional networking site, where medical professionals can keep track of their peers, seek/give advice from/to their peers, rate a FMG and healthcare job provider based upon their experience, buy/sell their insurance coverage during vacations, and share jobs with others. Additionally, the system will provide a platform to share industry information, articles, videos, recommendations, and opinions amongst all registrants, via email, messaging, and social networks.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

Additional general background, which helps to show variations and implementations, may be found in the following publications, all of which are hereby incorporated by reference herein for all purposes: U.S. Pat. No. 6,006,191, U.S. Pat. No. 6,035,288, and U.S. Pat. No. 7,657,479.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A job auction online software as a service for medical professionals, comprising:
a first central server machine hosting plurality of databases for data records; and
a second central server machine for hosting functional modules, said first server and second server being electronically connected, wherein said functional modules include at least a first module for medical professional registration, at least a second module for FMG registration, and at least a third module for conducting process of job auction;
wherein said first module, said second module, said third module interacts with each other and with said plurality of databases so that a registered medical professional who enters into a job bidding process is provided a matching score with said job, said medical professional is grouped into a bidding group, and said medical professional is allowed to stay in the job bidding process without placing a bid;
wherein said first module, said second module, said third module interacts with each other and with said plurality of databases so that a registered FMG who enters into a medical professional bidding process is provided a matching score with said professional, said FMG is grouped into a bidding group, and said FMG is allowed to stay in the job bidding process without placing a bid.

2. The job auction system of claim 1, wherein a healthcare facility or medical group specifies a job qualification weight factor for each job requirement for calculating said matching score, and a grouping preference for bidders.

3. The job auction system of claim 1, wherein a medical professional specifies a job preference weight factor for each job preference for calculating said matching score, and a grouping preference for bidders.

4. The job auction system of claim 1, wherein said medical professional registration includes license verification.

5. The job auction system of claim 1, wherein said FMG and medical professional has an option to choose a winner from said bidding group or no one at all.

6. The job auction system of claim 1, wherein said FMG and medical professional has an option to choose a medical professional or FMG respectively, who enters bidding process and has a matching score that is highest in said bidding process.

7. The job auction system of claim 1, wherein said medical professional or FMG who enters into a job bidding is allowed to place a second bid after a second bidder places a bid after said first bidding.

8. The job auction system of claim 1, further comprising a fourth module for socializing between medical professionals and facilities and medical groups.

9. The job auction system of claim 1, further comprising a fifth module for managing advertisers.

10. The job auction system of claim 1, further comprising a sixth module for managing account payment by a FMG.

11. The job auction system of claim 1, further comprising a seventh module that interacts with other professional and social networks.

12. A job auction system for claim 1, wherein registrants will be able to access the system remotely from hand held devices, like mobile phones and iPads.
